(19) United States
(12) Patent Application Publication
(10) Pub. No.: US 2026/0169506 A1
(43) Pub. Date: Jun. 18, 2026

(54) TRIPLE REDUNDANCY ASSEMBLY IN PROCESS CONTROL SYSTEMS

(71) Applicant: ROTEX AUTOMATION LIMITED, Vadodara (IN)

(72) Inventors: Nirav SHAH, Vadodara (IN); Rajesh SHAH, Vadodara (IN)

(21) Appl. No.: 18/712,333

(22) PCT Filed: Nov. 29, 2022
(86) PCT No.: PCT/IB2022/061520

§ 371 Date: May 22, 2024

(30) Foreign Application Priority Data
Nov. 29, 2021 (IN) 202121055228

(51) Int. Cl. G05D 7/06; F16K 37/00

(52) U.S. Cl. CPC G05D 7/0652; F16K 37/0058

(57) ABSTRACT

A valve system 350 for facilitating triple redundancy that is based on three pilot operated 5X2 solenoid valves (SOVs) incorporates isolation valves 500 to individually isolate any of the three SOVs 302 without affection functioning of the valve system 350, and visual indicator valves (VIVs) 400 to indicate true state of the corresponding solenoid valve 302. The isolation valves 500 include six valve side ports coupled to the ports of the corresponding SOV, and six line side ports coupled to fluid lines. VIVs 400 receive pressure signals from more than one fluid lines fluidically coupled to the corresponding SOV 302, and processes the pressure signals to move to an open position for providing an output pressure signal indicative of an energized state of The SOV 302.

### TECHNICAL FIELD

The present disclosure relates generally to arrangement of solenoid valves in instrumentation and process control systems of a plant, and more particularly to a manifold assembly system with solenoid valves.

### BACKGROUND

Background description includes information that may be useful in understanding the present invention. It is not an admission that any of the information provided herein is prior art or relevant to the presently claimed invention, or that any publication specifically or implicitly referenced is prior art.

A Safety Instrumented System (SIS) is used to monitor various parameters of a plant and check that the parameter values are within operational limits. In case of an unplanned or undesired event, SIS must trigger an alarm, and/or place the plant in a safe state or shut it down. Thus, SIS is responsible for the operational safety of the plant and enforcing an emergency stop whenever the operation exceeds safety limit(s). The main objective is to avoid accidents inside and/or outside the plant, such as fires, explosions, equipment damages, protection of production and property and, more than that, avoiding life risk or personal health damages and catastrophic impacts to community. Although no system is completely immune to failure, SIS ensures maximum possible safety in event of occurrence of a failure.

One of the key design parameters in safety instrumented system (SIS) design is the architecture or voting arrangements of the various subsystems that comprise a safety instrumented function (SIF). The architecture, or voting arrangement, is essentially the use of redundant pieces of equipment for the purpose of creating the ability to tolerate a failure of one component and still have the SIF perform its action. Selection of an appropriate voting arrangement will consider the failure modes of the SIS equipment, the level of safety that must be achieved and the rate of spurious failures and the associated consequences, financial or otherwise, of a spurious trip.

In process industry SIS design, there are several common voting arrangements. The most common voting arrangements used are one-out-of-one (1001), one-out-of-two (1002), two-out-of-two (2002), or two-out-of-three (2003) voting architecture. In the above nomenclature there are two parts to the voting arrangement description. The first number is the number of devices that must “vote” to cause a trip for the trip to occur. The second number is the total number of devices. Thus, in a 2002 voting arrangement, 2 devices must vote to trip, out of a total of two device, for the shutdown action to be taken.

In process industry solenoid valves serve to isolate and/or vent off a fluid or pneumatic source from the system when the solenoid valve changes state or position (e.g., when the valve is de-energized by switches or process monitoring sensors coupled thereto). The system may then be placed in a designated configuration for safety. The voting architecture 1001 involves a single channel system and is normally designed for low level safety applications. Failure of valve may result in an immediate loss of safety function or process closure as there is no redundancy to shut off production in the event of failure of that valve. The main disadvantage of a single safety system (that is, non-redundant) is that the any failure leads to an immediate tripping. There is also no guarantee that production can be rapidly restored. The voting architecture 1002 was developed to improve the performance of safety integrity of safety systems based on 1001. If a failure occurs in a channel, the other channel is still capable of providing the corresponding safety function. Unfortunately, the concept does not improve the rate of false trips. On the other hand, probability of false trip is almost doubled. The duplication of channels in a 2002 application significantly reduces the probability of a false trip, as both channels have to fail for the system to be placed under shutdown. However, the system has the disadvantage that the probability of failure on demand is twice higher than that of a single channel. In a 2003 voting architecture (also referred to as triple module redundancy, or triple mode redundancy, or simply as triple redundancy), there are three channels where two must be working in order to operate and comply with safety functions.

A conventional triple redundancy comprises four solenoid operated valves (SOV), out of which two of the solenoids are given an electrical signal from a common source to form 2003 voting architecture. However, use of four number of SOVs results in more components and a complex arrangement, thereby affecting reliability. Moreover, in case of a failure, the entire system may crumble and become difficult to manage leading to unplanned interruptions. Besides above, the conventional systems have no provision to isolate Visual Indicators and/or pressure switch for online maintenance. Therefore, to replace the Visual Indicator and/or pressure switch the whole system needs to be shut down. Since unplanned interruptions result in monetary losses in terms of lost production, as well as significant health, safety and legal issues associated with mechanical problems or systems failure, it would be advantageous to have redundancy in process control systems that can significantly reduce such unplanned interruptions and ensure both increased reliability and increased safety, as well as allow replacement of Visual Indicators and pressure switches without having to shut down the whole system.

Therefore, there is a requirement for an improved process control system that can overcome the aforementioned disadvantages and provide both higher level of safety and increased reliability with minimum usage of SOVs while also maintaining 2003 redundancy.

In some embodiments, the numbers expressing quantities of objects, properties, arrangements, and so forth, used to describe certain embodiments of the invention are to be understood as being modified in some instances by the term “about.” Accordingly, in some embodiments, the numerical parameters set forth are approximations that can vary depending upon the desired properties sought to be obtained by a particular embodiment.

As used in the description herein and throughout other sections that follow, the meaning of “a,” “an,” and “the” includes plural reference unless the context clearly dictates otherwise. Also, as used in the description herein, the meaning of “in” includes “in” and “on” unless the context clearly dictates otherwise.

### OBJECTS OF THE INVENTION

Some of the objects of the present disclosure, which at least one embodiment herein satisfies are as listed herein below.

A general object of the present disclosure is to provide for a triple redundancy system for facilitating safety and reliability in process control systems.

An object of the present disclosure is to provide a system for managing and reducing unplanned process interruptions while ensuring higher level of safety and continuous availability.

Another object of the present disclosure is to provide a reliable safety instrumented system which can ensure an uninterrupted supply.

Yet another object of the present disclosure is to provide a system which eliminates the chances of spurious trips and unplanned shutdowns.

Yet another object of the present disclosure is to provide a triple redundancy system for facilitating decrease in total weight of the entire assembly.

Still another object of the present disclosure is to provide a triple redundancy system that facilitates online maintenance without interrupting the function of the system.

Another object of the present disclosure is to provide a triple redundancy system for facilitating avoidance of connection of at least two solenoids to the same power source thereby reducing probability of potential electrical hazards.

Yet another object of the present disclosure is to provide a triple redundancy system which uses three SOVs and adheres to 2003 voting architecture with visual indicator valve and easy to interpret truth table.

Yet another object of the present disclosure is to provide a triple redundancy system including a feature of isolation of individual faulty SOVs for replacement/maintenance.

Still another object of the present disclosure is to provide a triple redundancy system that allows replacement of Visual Indicators and pressure switches without having to shut down the whole system.

### SUMMARY

Aspects of the present disclosure relate to a triple redundancy valve system to control a fluid flow between an input and an output. In an aspect, the disclosed valve system is based on pilot operated 5X2 solenoid valves, which reduces number of solenoid valves and other components in the system, besides eliminating the requirement of electrically connecting two solenoids with same power source, thereby reducing the risk of potential electrical hazards. In another aspect, the disclosed valve system incorporates isolation valves to individually isolate any of the three solenoid valves without affection functioning of the valve system, and at least one visual indicator valve to indicate true state of the corresponding solenoid valve.

In an aspect, the proposed valve system to selectively couple a fluid inlet with a fluid outlet includes three solenoid valves, such as a first solenoid valve, a second solenoid valve and a third solenoid valve, each of which is actuatable between an open position and a closed position and having a plurality of ports, and a plurality of fluid lines comprising inlet fluid lines and outlet fluid lines, each extending from a respective port of one of the solenoid valves to a port of another of the solenoid valves. The solenoid valves are disposed in serial fluid communication with one another with a single port of one of said solenoid valves configured as the fluid outlet. Actuation of any two of the first, second, and third solenoid valves alternately couples and decouples the fluid inlet with the fluid outlet. In an aspect, the valve system includes there isolation valves, such as a first isolation valve, a second isolation valve and a third isolation valve, respectively coupled to the three solenoid valves such that actuation of the any of the isolation valves results in isolation of the corresponding solenoid valve from the valve system.

In an embodiment, each of the solenoid valves is a pilot operated 5X2 solenoid valve comprising six ports.

In an embodiment, each of the isolation valve may include six valve side ports coupled to the ports of the corresponding solenoid valve, and six line side ports coupled to the fluid lines.

In an embodiment, each of the isolation valve may include a piston movable between a normal position and a bypass position. The piston may define a plurality of chambers configured such that, in the normal position of the piston, the plurality of chambers provide fluidic connectivity between each of the line side ports and the corresponding valve side ports, and in the bypass position, fluidic connectivity of all the valve side ports with the corresponding line side ports is blocked except for two valve side ports that are coupled to an exhaust port of the corresponding solenoid valve and another valve side port that is coupled to a port of the corresponding solenoid valve, which port is in turn coupled to a visual indicator valve of the valve system.

In an embodiment, the plurality of chambers may be configured such that, in the bypass position, two of the line side ports are fluidically connected to each other, one of the two line side ports being the port that corresponds to valve side port that is coupled to a pressure port of the corresponding solenoid valve, and the other of the two line side ports being the port corresponding to the valve side port, which is coupled to a port of the corresponding solenoid valve, which in turn is coupled to another of the three solenoid valves or to the fluid receiver.

In an aspect, the valve system based on three pilot operated 5X2 solenoid valves for triple redundancy includes at least one visual indication valve operatively coupled to at least one of the three solenoid valves. The visual indication valve is configured to receive pressure signals from more than one fluid lines fluidically coupled to the corresponding solenoid valve, and process the pressure signals to move to an open position for providing an output pressure signal indicative of an energized state of the corresponding solenoid valve.

In an embodiment, the visual indication valve may include a housing and a piston configured within the housing for linear movement between a closed position and the open position. The housing and the piston define a plurality of chambers of different cross sectional area. The visual indication valve may incorporate a plurality of ports configured for coupling of the plurality of chambers to the different fluid lines of the valve system.

In an embodiment, the housing may incorporate a stepped piston bore that includes a valve seat side portion, an intermediate portion and a biasing means side portion. The intermediate portion may be of a cross sectional area larger than cross sectional area of the valve seat side portion and the biasing means side portion. The piston may be a stepped piston having three piston heads, each sized corresponding to the valve seat side portion, the intermediate portion and the biasing means side portion of the bore. Engagement of the three piston heads with the corresponding portions of the piston bore results in two of the plurality of chambers having pistons of different cross sections on opposite sides of the chamber, thereby resulting in processing of the pressure signals from the corresponding valve.

An aspect of the present disclosure also relate to an isolation valve configured to be actuated from a normal position to a bypass position, and configured between the corresponding solenoid valve of the valve system and a plurality of fluid lines fluidically coupled to a respective port of the corresponding solenoid valve. In the bypass position the isolation valve isolates the corresponding solenoid valve from the valve system while allowing normal functioning of the valve system.

Another aspect of the present disclosure relates to a visual indicator valve for indication of a true position of a 5X2 solenoid valve in a valve system, the visual indicator valve being configured to be operatively coupled to a solenoid valve of a valve system such that the visual indication valve receives pressure signals from more than one fluid lines fluidically coupled to the corresponding solenoid valve. The visual indicator valve is configured to process the pressure signals to move to an open position for providing an output pressure signal indicative of an energized state of the corresponding solenoid valve.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a circuit diagram of a conventional triple redundancy valve system (RV323P) using three numbers of 3/2-way-SOVs.

FIGS. 2A-2B illustrate circuit diagrams of a conventional triple redundancy valve system (RV323, RV323D) using four numbers of 3/2-way-SOVs.

FIG. 3A illustrates an exemplary circuit diagrams of a proposed triple redundancy valve system (RV323F) using a common bypass valve (BP) for isolating the complete valve system and visual indicator valves (VIVs) coupled to two of the three SOVs for indication of true state of the corresponding SOV, in accordance with an embodiment of the present disclosure.

FIG. 3B illustrates anexemplary circuit diagram of the proposed triple redundancy valve system (RV323F) using three numbers of 5X2 SOVs, wherein the valve system includes individual isolation valves for individually isolating each of the SOVs and visual indicator valves (VIVs) coupled to two of the three SOVs for indication of true state of the corresponding SOV, in accordance with an embodiment of the present disclosure.

FIGS. 4A-4B illustrate exemplary cross sectional views of the disclosed VIV used in the valve system of FIGS. 3A and 3B, respectively showing closed condition and open condition of the VIV, in accordance with an embodiment of the present disclosure.

FIGS. 5A-5B illustrate exemplary cross sectional views of the disclosed isolation valves used in the proposed system of FIG. 3B, respectively showing normal mode and bypass mode of the isolation valve, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Various terms are used herein. To the extent a term used herein is not defined, it should be given the broadest definition persons in the pertinent art have given that term as reflected in printed publications and issued patents at the time of filing.

The present disclosure relates generally to valve systems configured between an input and an output for controlling flow of a fluidic media from the input to the output, such as in an in instrumentation and process control systems of a plant. More particularly, the present disclosure relates to a valve system that implements 2003 voting/logic circuit (triple redundancy).

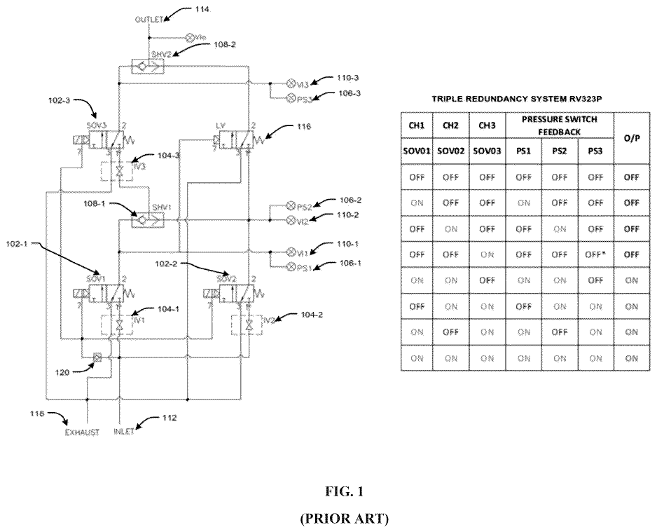

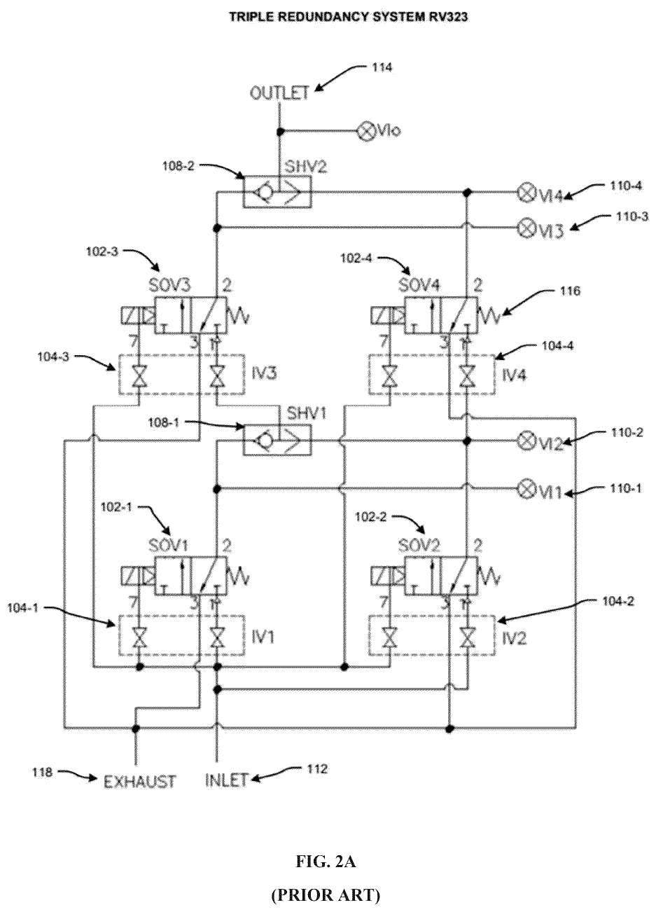

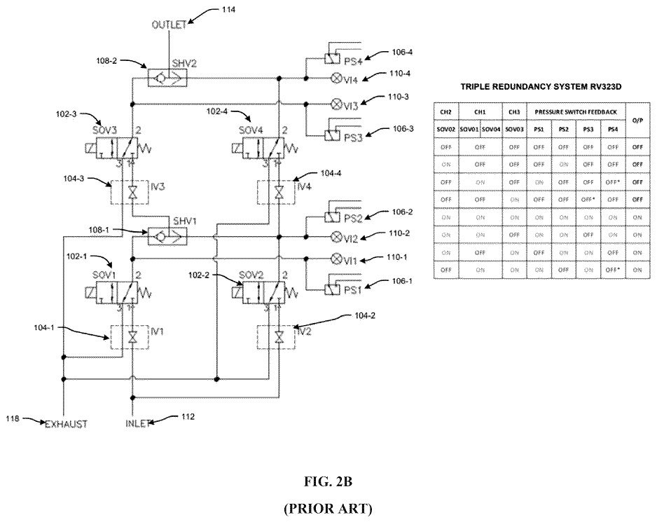

In a typical 2003 logic circuit three independent inputs are used, and output of the 2003 logic circuit maybe the same state as any two matching input states. For example, in a safety circuit where three Solenoid Operated Valves (SOVs) are included, a power supply signal to any two SOVs or absence thereof may result in the valve opening or closing respectively. In practice, various type of 2003 logic circuits have been in use. In one example, a 2003 logic circuit RV323 uses four 3/2-way-SOVs with one or more shuttle valves. The SOVs may be pilot operated (as shown in FIG. 2A). In another example, a RV323D logic circuit may use four 3/2-way-SOVs which are direct operated (as shown in FIG. 2B). In another example, a RV323Plogic circuit may use three 3/2-way-SOVs with one or more shuttle valves (as shown in FIG. 1).

In a conventional 2003 Modular Redundant Valve Block (MRVB) system, tripping of any two Digital Outputs (Dos), or SOVs corresponding to these two Dos may trigger tripping of a main valve. Because of this triple redundancy the 2003 MRVB system are used where both safety and availability is required. In the 2003 MRVB system, online maintenance, without interrupting the function of the system, may be achieved through an online maintenance valve, which is a common bypass valve.

In a typical 2003 MRVB systems, triple redundancy may comprise four or more SOVs, in which two or more SOVs may be given an electrical signal from a common source, to form a 2003 logic circuit. However, two or more shuttle valves included in the system do not have any feedback mechanism. Therefore, in case of a fault in a shuttle valve, the system may trip and the failure may go undetected. Also, false negative feedbacks is noticed in respect of pressure switches or local visual indicators.

A triple redundancy circuit may use at least three 3/2 solenoid valves. The circuit may be designed in such a manner that the 2003 architecture may use three SOVs instead of four or more SOVs. Any additional SOV, beyond the three SOVs used in the circuit, is replaced by Air Operated Logic Valve, which may be incorporated inside the assembly. This circuit may include at least two shuttle valves and at least one air operated logic valve arrangement. However, it is possible that a failure of any component of the logic valve and/or shuttle valves can go undetected, which poses a threat of spurious trips and unplanned shutdowns.

FIG. 1 illustrates a circuit diagram of a conventional triple redundancy system using three of 3/2SOVs. As illustrated, the circuit includes three solenoid valves 102-1, 102-2 and 102-3 (also referred individually as solenoid valve 102 or SOV 102 and collectively as solenoid valves 102 or SOVs 102) having a plurality of ports. Shuttle valves 108-1 and 108-2 (also referred collectively as shuttle valves 108 or SHVs 108 or individually shuttle valve 108 or SHV 108) are operatively coupled to the solenoid valves 102.

The triple redundancy system using three of 3/2-way-SOVs shown in FIG. 1 further includes an inlet pathway 112 directly extending from a respective port of a first solenoid valve 102-1 to a port of a second solenoid valve 102-2. The first solenoid valve 102-1 and the second solenoid valve 102-2 are fluidically connected to each other through a first shuttle valve 108-1. The inlet pathway 112 is further discreetly connected to a port of a third solenoid valve 102-3 through a non-return valve 120 (also referred to as NRV 120). The system further includes an outlet 114 extending from a second shuttle valve 108-2 connected to the third solenoid valve 102-3 and a logic control valve 116 (also referred to as logic valve 116 or LV, for example LV). The LV 116 is operatively coupled to the three solenoid valves 102 and the two shuttle valves 108 to regulate the flow of fluid to control the operation of the three solenoid valves 102 as a mechanism to interrupt an operation of the valve system of FIG. 1, when actuation of at least any two of the first, second and third solenoid valves 102 may fail. The LV 116 is further coupled to an online maintenance valve configured to provide maintenance without interrupting functioning of the system.

The LV 116 may be placed inside the manifold assembly to replace a fourth solenoid valve abolishing a requirement of the fourth solenoid valve and a plurality of sub-assemblies connected to the fourth solenoid valve. Four visual indicators 110-1, 110-2, 110-3 and 110-4 (referred collectively as visual indicators 110 or VI, for example VI 1, VI 2, . . . , etc.) are provided to detect presence of air pressure. Visual indicators 110 provide a visual indication of air pressure within pneumatic systems. Several types of pneumatic visual indicator are available with high visibility lenses that extend beyond the panel surface to provide a clear visible indication for the presence of air pressure.

The non-return valve 120 or NRV 120are configured to allow flow of a fluid in a predefined direction. There may be different types of non-return valves, such as spring-loaded, swing type, and clapper type valves but not limited to the like.

An exhaust 118 is operatively coupled to the three solenoid valves, the two shuttle valves and the logic control valve.

FIGS. 2A-2B illustrate circuit diagrams of other conventional triple redundancy systems using four of 3/2-way-SOVs. As illustrated therein, the conventional systems include an extra or a fourth solenoid valve 102-4 to form 2003 logic circuit. FIG. 2A depicts use of four isolation valves 104-1, 104-2, 104-3 and 104-4 (also referred to as IV, for example IV 1, IV 2, . . . , etc.) whereas FIG. 2B depicts four pressure switches 106-1, 106-2, 106-3 and 106-4 (also referred to as PS, for example PS 1, PS 2, . . . , etc.).

The present disclosure provides a triple redundancy valve system for controlling flow of a fluidic media from an input to an output, that implements 2003 voting/logic circuit (triple redundancy) based on use of three pilot operated 5X2 solenoid valves. In different embodiments, the disclosed valve system based on three pilot operated 5X3 SOVs incorporates isolation valves to individually isolate any of the three solenoid valves without affection functioning of the valve system, and at least one visual indicator valve to indicate true state of the corresponding solenoid valve either in combination with the isolation valves for individual isolation of each of the SOVs or with a bypass valve to isolate the entire valve system.

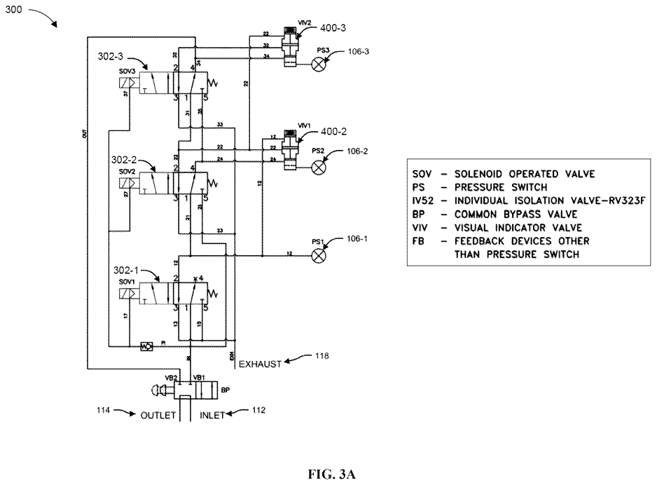

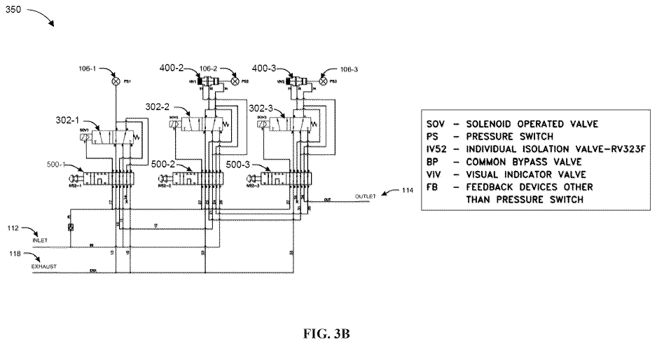

Referring now to FIG. 3A, where an exemplary circuit diagram of the proposed triple redundancy system using three of 5X2SOVs 102 is disclosed, the valve system 300 includes three pilot operated 5X2 solenoid valves, such as a first solenoid valve 302-1, a second solenoid valve 302-2 and a third solenoid valve 302-3 (individually and collectively referred to as solenoid valves 302 or SOV 302, herein). Each SOV 302 is actuatable between an open position and a closed position and, being pilot operated 5X2 SOVs, include six ports. A plurality of fluid lines, which include inlet fluid lines and outlet fluid lines, extend from a respective port of one of the SOV 302 to a port of another SOV 302. The SOVs 302 are disposed in serial fluid communication with one another with a single port of SOV 302-3 coupled to an outlet 114.

In an aspect, the SOVs 302 are connected to each other such that actuation of any two of the three SOVs 302 alternately couples and decouples the fluid inlet 112 with the fluid outlet 114. For example, only when any two of the SOVs 302 are in open condition, inlet 112 is fluidically connected to the outlet 114, and when any two of the three SOVs 302 are in closed condition, the fluidic connectivity between the inlet 112 and the outlet 114 is blocked.

In an aspect, the valve system 300 further includes at least one visual indicator valve (VIV), such as VIV1 400-2 and VIV2 400-3 (Collectively referred to as VIV 400, herein) coupled to the SOVs 302-2 and 302-3 respectively. The valve system 300 includes a common bypass valve BP to isolate the valve system from the inlet 112 and the outlet 114, i.e., connecting the inlet 112 and the outlet 114 directly bypassing the valve system 300, such as for maintenance of the valve system 300.

The visual indication valve 400 are configured to receive pressure signals from more than one fluid lines, such as lines 24, 22 and 21/12 for the VIV 400-2, and from the lines 34, 32 and 31/22 for the VIV 400-2, which fluidically couple the VIVs to the corresponding solenoid valves 302. The VIVs 400 process the pressure signals to move to an open position for providing an output pressure signal indicative of an energized state of the corresponding solenoid valve. The signal can be fed to a pressure switch, such as PS 106-2 and 106-3 respectively.

Referring now to FIG. 3B, in an aspect, the valve system 350 includes there isolation valves, such as a first isolation valve 500-1, a second isolation valve 500-2 and a third isolation valve 500-3 (collectively and individually referred to as isolation valve 500, herein),

TRUTH TABLE - RV323F - WITH PRESSURE SWITCH

| NO. | SOV1 | SOV2 | SOV3 | PS1 | 12 | 22 | 24 | PS2 | VIV1 | 22 | 32 | 34 | PS3 | VIV2 | OUT |
|---|---|---|---|---|---|---|---|---|---|---|---|---|---|---|---|
| 1 | OFF | OFF | OFF | OFF | NP | NP | NP | OFF | OFF | NP | NP | NP | OFF | OFF | OFF |
| 2 | ON | OFF | OFF | ON | P↓ | NP | NP | OFF | OFF | NP | NP | NP | OFF | OFF | OFF |
| 3 | OFF | ON | OFF | OFF | NP | P↑ | P↑ | ON | ON | P↓ | NP | NP | OFF | OFF | OFF |
| 4 | OFF | OFF | ON | OFF | NP | NP | NP | OFF | OFF | P↓ | NP | P↑ | OFF* | OFF* | OFF |
| 5 | ON | ON | OFF | ON | P↓ | P↑ | P↑ | ON | ON | P↓ | NP | NP | OFF | OFF | ON |
| 6 | ON | OFF | ON | ON | P↓ | NP | NP | OFF | OFF | NP | P↑ | P↑ | ON | ON | ON |
| 7 | OFF | ON | ON | OFF | NP | P↑ | P↑ | ON | ON | NP | P↑ | P↑ | ON | ON | ON |
| 8 | ON | ON | ON | ON | P↓ | P↑ | P↑ | ON | ON | P↓ | P↑ | P↑ | ON | ON | ON |

place of the common bypass valve BP, of the valve system 300 shown in FIG. 3A. The there're isolation valves 500 can be respectively coupled to the three solenoid valves 302 such that actuation of the any of the isolation valves 500 results in isolation of the corresponding solenoid valve 302 from the valve system 300, such as for maintenance or replacement of the corresponding SOV 302, without affection functioning of the fluid system 300.

In an embodiment, each of the isolation valves 500 can include six valve side ports, numbered 1 to 7 for coupling the isolation valve 500 to the similarly numbered ports of the corresponding solenoid valves 302, and six line side ports, numbered A to F for coupling the fluid lines.

Also shown in FIG. 3B are VIVs 500 coupled to the SOVs 302 for generating pressure signal corresponding to the state of the corresponding SOV.

The table below shows truth table for the valve systems 300 and 350 shown in FIGS. 3A and 3B positions of output and the two VIVs 400 under different combinations of states of SOVs 302. i.e., SOV1. SOV2 and SOV3:

In the above table, P indicates presence of pressure in the line and accordingly in the corresponding chamber of the VIV 400, NP indicates absence of pressure in the corresponding line and accordingly in the corresponding chamber of the VIV 400. An up arrow with P indicates that the presence of pressure in the line and the corresponding chamber tending to opening of the corresponding VIV 400, and a down arrow with P indicates that the presence of pressure in the line and the corresponding chamber tending to closing of the corresponding VIV 400, wherein opening or closing of the VIV 400 under condition of presence of pressure in different chambers is determined by cross sectional areas of the chambers.

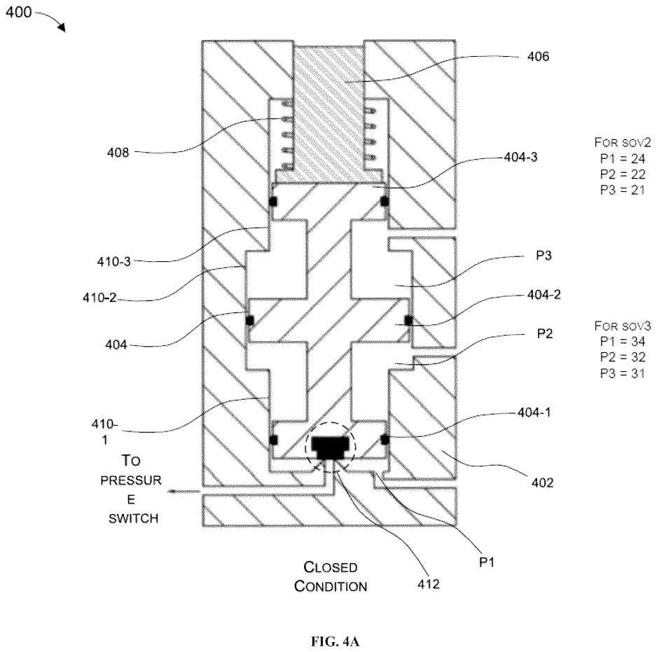

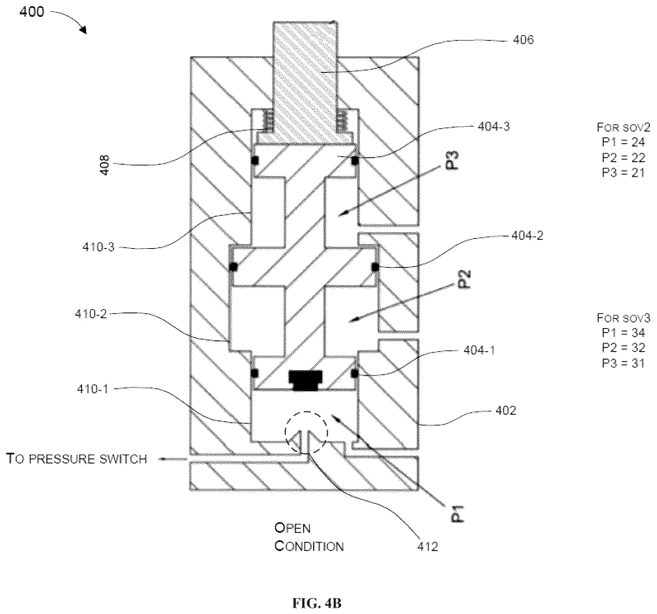

FIGS. 4A-4B illustrate exemplary sectional views of the visual indicator valve 400 used in the system of FIGS. 3A and 3B. FIG. 4A illustrates a closed condition/state of the visual indicator valve 400, whereas FIG. 4B illustrates an open condition/state of the visual indicator valve 400. The visual indicator valve 400 may receive pressure signals from various pressure channels and process the received pressure signals to show indication of energized condition of corresponding SOV (as depicted in FIGS. 3A-3B). By using the proposed visual indicator valve mechanism, an accurate pressure signal for pressure switch or such pneumatically activated sensors can be provided for control room feedback. OFF* indicates that the corresponding SOV-3 is ON but the corresponding VIV and PS indicated OFF.

In an embodiment, as shown in FIGS., 4A and 4B, the visual indication valve 400 may include a housing 402 and a piston configured 404 within the housing for linear movement between a closed position, shown in FIG. 4A, in which the piston 404 moves to left to close the valve 412, and an open position, as shown in FIG. 4B, in which the piston 404 moves to right to open the valve 412 . . . . The housing 402 and the piston 404 define a plurality of chambers, such as chambers P1, P2 and P3, each of different cross sectional area. The VIV 400 further incorporates a plurality of ports configured for coupling of the plurality of chambers P1, P2 and P3 to the different fluid lines of the valve system 300/350. The VIV 400 also includes a biasing means, such as a spring 408, to bias the piston 404 towards a seat of the valve 412, and a visual indicator 406, which in completely housed within the housing 402 in the closed position of the VIV 400, as shown in FIG. 4A, and gets pushed out of the housing when the VIV 400 is in the open position, as shown in FIG. 4B, to provide a visual indication about the status of the corresponding SOV 302.

In an embodiment, the housing 402 can have a stepped piston bore that includes a valve seat side portion 410-1, an intermediate portion 410-2 and a biasing means side portion 410-3 (collectively referred to as bore 410, herein). The intermediate portion 410-2 can have a larger cross sectional area than cross sectional area of the valve seat side portion 410-1 and the biasing means side portion 410-3. The piston 404 can be a stepped piston having three piston heads, such as 404-1, 404-2 and 404-3 (collectively referred to as piston 404, herein), each sized corresponding to the valve seat side portion 410-1, the intermediate portion 410-2 and the biasing means side portion 410-3 of the bore 410. Engagement of the three piston heads 404-1, 404-2 and 404-3 with the corresponding portions of the piston bore 410 results in two of the plurality of chambers P1, P2 and P3 having pistons of different cross sections on opposite sides of the chamber, thereby resulting in processing of the pressure signals from the corresponding SOV 302.

In an embodiment, usage of the visual indicator valve 400, illustrated in FIGS. 4A-4B, may provide signal for pressure switch and in-field visual indication. The use of visual indicator valve can also help in easy fault detection and/or achieving detailed Truth Table which can be fairly easy to interpret.

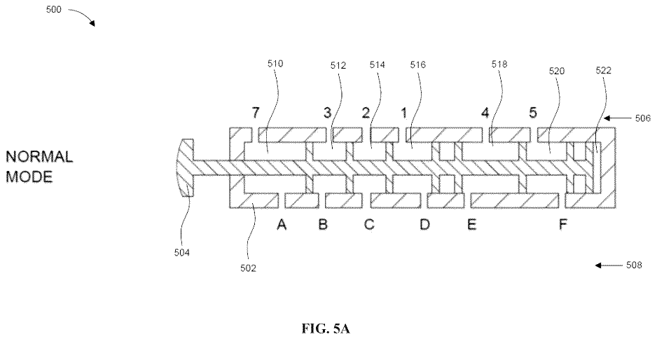

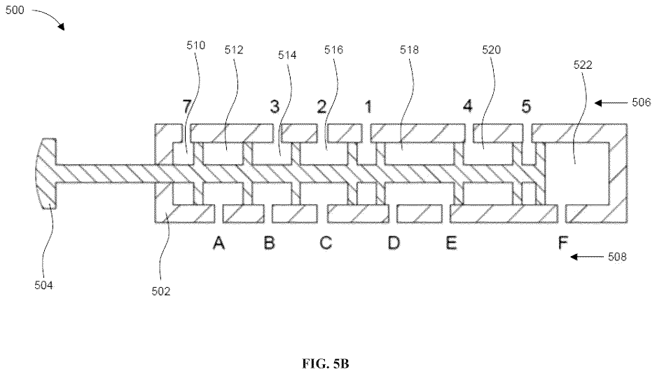

FIGS. 5A-5B illustrate exemplary cross sectional views of the isolation valve 500 used in the valve system 350 of FIG. 3B, wherein FIG. 5A illustrates the isolation valve 500 in a normal mode, and FIG. 5B illustrates the isolation valve 500 in a bypass mode. As stated earlier, the isolation valve 500 is a device that is operatively coupled to a SOV 302 of the valve system 350 and is configured to isolate the corresponding SOV 302 from the system to facilitate maintenance or replacement, thereby the isolation valves 500 provide an independent bypass provision for each of the three SOVs in the valve system 350 of FIG. 3B. The novel concept helps in avoiding a bypass of the entire system and only the SOV 302 with fault can be replaced or taken for maintenance without interrupting the operation of the system.

In an embodiment, as shown in FIGS. 5A and 5B, the isolation valve 500 have a piston 504 movable configured in a housing 502 for movement between a normal position, shown in FIG. 5A, and a bypass position, shown in FIG. 5B. The piston 504 defines a plurality of chambers, such as chambers 510, 512, 514, 516, 518, 520 and 522, configured such that, in the normal position of the piston 502, the plurality of chambers provide fluidic connectivity between each of the line side ports 508, numbered as A to F, and the corresponding valve side ports 506, numbered as 1 to 7. In the bypass position, fluidic connectivity of all the valve side ports 506 with the corresponding line side ports 508 is blocked except for two valve side ports, i.e., port 3 which is coupled to an exhaust port of the corresponding solenoid valve 302 and port 2 which is coupled to a port of the corresponding solenoid valve 302, which in turn is coupled to a visual indicator valve 400 of the valve system 350.

In an embodiment, the plurality of chambers may be configured such that, in the bypass position, two of the line side ports 508, such as ports D and E, are fluidically connected to each other.

Thus the present disclosure provides an improved valve system for 2003 logic overcoming the disadvantage of conventional 2003 logic circuits in respect of more 3/2-way-SOVs, and more components. Therefore, in case of failure, an improved 2003 logic circuit having only three of 5X2 SOVs, would provide a better reliability in comparison to the conventional 2003 logic circuit having four of 3/2-way-SOVs.

In an embodiment, by eliminating shuttle valve, for example, in a 2003 logic circuit having three of 5X2 SOVs, the chances of undetected failures can be avoided. This may in turn eliminate the chances of spurious trips and unplanned system shutdowns.

In another embodiment, in case of application with requirement of intrinsically safe model, two valves which may be connected to a common power source in other applications, may need to have separate connections from intrinsically safe barrier. Therefore, the configuration with four quantities of SOVs may actually become 2004 circuit. However, if three quantities of SOVs is selected, it may result in truly 2003 configuration.

In another embodiment, reducing the number of SOVs to three instead of four eliminates the requirement of electrically connecting two solenoids with same power source. This may reduce the probability of potential electrical hazards.

In yet another embodiment, in the conventional systems, there may be false negative feedbacks in case of pressure switches or local visual indicators. However, in systems including 2003 logic circuit having three quantities of 5X2 SOVs, such false negatives may be reduced.

In another embodiment, by avoiding the requirement of the fourth SOV, one less local visual indicator, pressure switch or reed switch shall be required, which results in decreased total weight of the entire assembly. In an embodiment, in a 2003 logic circuit having three of 3/2-way-SOVs, shuttle valves and arrangement of air operated logic valve may be required in the circuit. On the other hand, a 2003 logic circuit having three of 5X2 SOVs shall not require any shuttle valve or logic valve to achieve 2003 configuration.

In another embodiment, since shuttle valve and logic valve arrangement may not have any feedback to show failure, eliminating shuttle valve and logic valve arrangement results in avoiding chances of undetected failures. This may result in decrease in the chances of spurious trips.

In another embodiment, a 2003 logic circuit having three of 5X2 SOVs may provide an arrangement which could results in easy fault detection, for example, the control room feedback may be fairly easy to interpret and understand in truth table of the proposed 2003 logic circuit having three of 5X2 SOVs, as depicted in FIGS. 3A-3B, when compared to truth tables of contemporary logic circuits. In an exemplary embodiment, ambiguities may be eliminated by providing a sophisticated arrangement for SOV-to-SOV feedback as in the 2003 logic circuit having three quantities of 5X2 SOVs.

In yet another embodiment, with a 2003 logic circuit having three 5X2 SOVs, an option for provision of isolation of individual SOVs and VIVs can also be provided. Thus, only targeted or faulty SOV and/or VIV can be isolated for replacement or maintenance purpose.

One of ordinary skill in the art will appreciate that techniques consistent with the present disclosure are applicable in other contexts as well without departing from the scope of the disclosure.

While the foregoing describes various embodiments of the invention, other and further embodiments of the invention may be devised without departing from the basic scope thereof. The scope of the invention maybe determined by the claims. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides a triple redundancy system for facilitating safety and reliability in process control systems.

The present disclosure provides a system for managing and reducing unplanned process interruptions while ensuring higher level of safety and continuous availability.

The present disclosure provides a reliable safety instrumented system which can ensure an uninterrupted continuous supply.

The present disclosure provides a system which eliminates the chances of spurious trips and unplanned shutdowns.

The present disclosure provides a triple redundancy system for facilitating decrease in total weight of the entire assembly.

The present disclosure provides a triple redundancy system that facilitates online maintenance without interrupting the function of the system.

The present disclosure provides a triple redundancy system that facilitates easy to interpret and understand truth table in comparison to truth tables of conventional systems.

The present disclosure provides a triple redundancy system for facilitating avoidance of connection of at least two solenoids to the same power source thereby reducing probability of potential electrical hazards.

The present disclosure provides a redundancy system which uses three SOVs and adheres to 2003 voting architecture with visual indicator valve and easy to interpret truth table.

The present disclosure provides a more reliable triple redundancy system as it effectively averts chances of undetected failures because there is no need for shuttle valve(s) and/or logic valve(s).

The present disclosure provides a triple redundancy system which achieves extended reliability by decreasing number of assemblies, such as fourth SOV, used to construct 2003 architecture in conventional triple redundancy systems.

The present disclosure provides a triple redundancy system including a feature of isolation of individual faulty SOVs and VIVs for online replacement/maintenance.

The present disclosure provides a triple redundancy system that allows replacement of Visual Indicators and pressure switches without having to shut down the whole system.

We claim:

1. A valve system to selectively couple a fluid inlet with a fluid outlet, the valve system comprising:
three solenoid valves comprising a first solenoid valve, a second solenoid valve and a third solenoid valve, each of the solenoid valves, actuatable between an open position and a closed position and having a plurality of ports;
a plurality of fluid lines comprising inlet fluid lines and outlet fluid lines, each extending from a respective port of one of the solenoid valves to a port of another of the solenoid valves, wherein the solenoid valves are disposed in serial fluid communication with one another;
wherein a single port of one of said solenoid valves is configured as the fluid outlet;
wherein actuation of any two of the first, second, and third solenoid valves alternately couples and decouples the fluid inlet with the fluid outlet; and
wherein the valve system further comprises a first isolation valve, a second isolation valve and a third isolation valve respectively coupled to the first solenoid valve, the second solenoid valve, and the third solenoid valve such that actuation of the any of the isolation valves results in isolation of the corresponding solenoid valve from the valve system.

2. The valve system as claimed in claim 1, wherein each of the solenoid valves is a pilot operated 5X2 solenoid valve comprising six ports.

3. The valve system as claimed in claim 2, wherein each of the isolation valve comprises six valve side ports coupled to the ports of the corresponding solenoid valve, and six line side ports coupled to the fluid lines.

4. The valve system as claimed in claim 3, wherein each of the isolation valve comprises a piston movable between a normal position and a bypass position.

5. The valve system as claimed in claim 4, wherein the piston defines a plurality of chambers configured such that, in the normal position of the piston, the plurality of chambers provide fluidic connectivity between each of the line side ports and the corresponding valve side ports, and in the bypass position, fluidic connectivity of all the valve side ports with the corresponding line side ports is blocked except for two valve side ports that are coupled to an exhaust port of the corresponding solenoid valve and another valve side port that is coupled to a port of the corresponding solenoid valve, which port is in turn coupled to a visual indicator valve of the valve system.

6. The valve system as claimed in claim 5, wherein the piston defines a plurality of chambers configured such that, in the bypass position, two of the line side ports are fluidically connected to each other, one of the two line side ports being the port that corresponds to valve side port that is coupled to a pressure port of the corresponding solenoid valve, and the other of the two line side ports being the port corresponding to the valve side port, which is coupled to a port of the corresponding solenoid valve, which in turn is coupled to another of the three solenoid valves or to the fluid receiver.

7. An isolation valve for isolating a pilot operated 5X2 solenoid valve in a valve system, the isolation valve being configured to be actuated from a normal position to a bypass position, and configured between the corresponding solenoid valve of the valve system and a plurality of fluid lines fluidically coupled to a respective port of the corresponding solenoid valve;
wherein, in the bypass position the isolation valve isolates the corresponding solenoid valve from the valve system while allowing normal functioning of the valve system.

8. The isolation valve as claimed in claim 7, wherein the isolation valve comprises a housing and a piston movable within the housing between the normal position and the bypass position, wherein the isolation valve comprises six valve side ports for being coupled to the ports of the corresponding solenoid valve, and six line side ports for being coupled to the fluid lines.

9. The isolation valve as claimed in claim 8, wherein the piston defines a plurality of chambers configured such that, in the normal position of the piston, the plurality of chambers provide fluidic connectivity between each of the line side ports and the corresponding valve side ports, and in the bypass position, fluidic connectivity of all the valve side ports with the corresponding line side ports is blocked except for two valve side ports that are coupled to an exhaust port of the corresponding solenoid valve and another valve side port that is coupled to a port of the corresponding solenoid valve, which port is in turn coupled to a visual indicator valve of the valve system.

10. The isolation valve as claimed in claim 8, wherein the piston defines a plurality of chambers configured such that, in the bypass position, two of the line side ports are fluidically connected to each other, one of the two line side ports being the port that corresponds to valve side port that is coupled to a pressure port of the corresponding solenoid valve, and the other of the two line side ports being the port corresponding to the valve side port, which is coupled to a port of the corresponding solenoid valve, which in turn is coupled to another of the three solenoid valves or to the fluid receiver.

11. A valve system to selectively couple a fluid inlet with a fluid outlet, the valve system comprising:
three solenoid valves comprising a first solenoid valve, a second solenoid valve and a third solenoid valve, each of the solenoid valves, actuatable between an open position and a closed position and having a plurality of ports;
a plurality of fluid lines comprising inlet fluid lines and outlet fluid lines, each extending from a respective port of one of the solenoid valves to a port of another of the solenoid valves, wherein the solenoid valves are disposed in serial fluid communication with one another;
wherein a single port of one of said solenoid valves is configured as the fluid outlet;
wherein actuation of any two of the first, second, and third solenoid valves alternately couples and decouples the fluid inlet with the fluid outlet; and
wherein the valve system further comprises at least one visual indication valve operatively coupled to at least one of the three solenoid valves, the visual indication valve configured to receive pressure signals from more than one fluid lines fluidically coupled to the corresponding solenoid valve, and process the pressure signals to move to an open position for providing an output pressure signal indicative of an energized state of the corresponding solenoid valve.

12. The valve system as claimed in claim 11, wherein the visual indication valve comprises a housing and a piston configured within the housing, the housing and the piston defining a plurality of chambers of different cross sectional area, and wherein the visual indication valve incorporates a plurality of ports configured for coupling of the plurality of chambers to the different fluid lines of the valve system.

13. The valve system as claimed in claim 12, wherein the housing incorporates a stepped piston bore comprising a valve seat side portion, an intermediate portion and a biasing means side portion, wherein the intermediate portion is of a cross sectional area larger than cross sectional area of the valve seat side portion and the biasing means side portion, and wherein the piston is a stepped piston having three piston heads, each sized corresponding to the valve seat side portion, the intermediate portion and the biasing means side portion of the bore, and wherein engagement of the three piston heads with the corresponding portions of the piston bore results in two of the plurality of chambers having pistons of different cross sections on opposite sides of the chamber, thereby resulting in processing of the pressure signals from the corresponding valve.

14. A visual indicator valve for indication of a true position of a 5X2 solenoid valve in a valve system, the visual indicator valve being configured to be

[symbol]

15. valve operatively coupled to a solenoid valve of the valve system such that the visual indication valve receives pressure signals from more than one fluid lines fluidically coupled to the corresponding solenoid valve, wherein the visual indicator valve is configured to process the pressure signals to move to an open position for providing an output pressure signal indicative of an energized state of the corresponding solenoid valve.

16. The visual indicator valve as claimed in claim 14, wherein the visual indication valve comprises a housing and a piston configured within the housing, the housing and the piston defining a plurality of chambers of different cross sectional area, and wherein the visual indication valve incorporates a plurality of ports configured for coupling of the plurality of chambers to the different fluid lines of the valve system.

17. The visual indicator valve as claimed in claim 16, wherein the housing incorporates a stepped piston bore comprising a valve seat side portion, an intermediate portion and a biasing means side portion, wherein the intermediate portion is of a cross sectional area larger than cross sectional area of the valve seat side portion and the biasing means side portion, and wherein the piston is a stepped piston having three piston heads, each sized corresponding to the valve seat side portion, the intermediate portion and the biasing means side portion of the bore, and wherein engagement of the three piston heads with the corresponding portions of the piston bore results in two of the plurality of chambers having pistons of different cross sections on opposite sides of the chamber, thereby resulting in processing of the pressure signals from the corresponding valve.
